(19) United States
(12) Patent Application Publication
(10) Pub. No.: US 2026/0105132 A1
(43) Pub. Date: Apr. 16, 2026

(54) Generative Artificial Intelligence (Ai) Driven Conversational Authentication

(71) Applicant: Kyndryl, Inc., New York, NY (US)

(72) Inventors: Cesar Augusto RODRIGUEZ BRAVO, Alajuela (CR); Omar ODIBAT, Cedar Park, TX (US); Manish MITRUKA, Pune (IN); Li Long CHEN, Beijing (CN)

(21) Appl. No.: 18/916,853

(22) Filed: Oct. 16, 2024

(51) Int. Cl. G06F 21/31

(52) U.S. Cl. CPC G06F 21/31; G06F 2221/2103

(57) ABSTRACT

Generating authentication security questions using generative AI includes receiving a request from a user to access a protected resource and generating the authentication security question based on knowledge about the user. The receipt of the request causes the authentication security question to be generated. The technique includes presenting the authentication security question to the user, and in response to a user answer for the authentication security question being correct, granting the user access to the protected resource.

### BACKGROUND

The present invention relates generally to computer systems, and more specifically, to computer-implemented methods, computer systems, and computer program products configured and arranged to generate authentication security questions using generative Artificial Intelligence (AI).

Cyberspace is particularly difficult to secure due to a number of factors, including the ability of malicious actors to operate from anywhere in the world, the linkages between cyberspace and physical systems, and the difficulty of reducing vulnerabilities and consequences in complex cyber networks. Accordingly, implementing safe cybersecurity ‘best practices’ is beneficial for individuals as well as organizations of all sizes, where the ‘best practices’ typically include using strong passwords, encryption, firewalls, etc. Additionally, cybersecurity best practices often recommend an additional security layer for protecting online accounts and sensitive data. One prevalent type of security layer involves the use of security questions for password recovery, Multifactor Authentication (MFA) setup, device authorization, and transaction verification. These questions help verify user identity by offering an extra layer of defense against unauthorized access, thereby enhancing overall account security.

### SUMMARY

Embodiments are directed to a computer-implemented method for generating authentication security questions using generative Artificial Intelligence (AI). The non-limiting method includes receiving a request from a user to access a protected resource and generating the authentication security question based on knowledge about the user. The receipt of the request causes the authentication security question to be generated (e.g., in real-time). The method includes presenting the authentication security question to the user, and in response to a user answer for the authentication security question being correct, granting the user access to the protected resource.

Other embodiments of the present invention implement features of the above-described methods in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2A depicts a block diagram of a system for generating authentication security questions using generative Artificial Intelligence (AI), according to an embodiment of the present invention;

FIG. 2B is a flow diagram illustrating a method for generating authentication security questions using generative AI, according to an embodiment of the present invention;

FIG. 3 is a block diagram illustrating a method for generating authentication security questions using generative AI, according to an embodiment of the present invention;

FIGS. 4A and 4B depict a block diagram illustrating a method with a privacy mode for generating authentication security questions using generative AI, in accordance with another embodiment of the present invention;

FIG. 5 is a block diagram illustrating a method for generating authentication security questions using generative AI, in accordance with one or more embodiments of the present invention;

FIG. 6 depicts a cloud computing environment according to one or more embodiments of the present invention; and

FIG. 7 depicts abstraction model layers according to one or more embodiments of the present invention.

### DETAILED DESCRIPTION

One or more embodiments are configured and arranged to generate an authentication security question using commonly available generative Artificial Intelligence (AI) models. The security question is based on a user or agent’s recent and/or real-time activities or other private information about the user, thereby enhancing access security and efficiency and eliminating the need for pre-set questions. One or more embodiments automatically verify the semantics of a user response, rather than relying on exact text matches. This approach significantly improves a user’s experience by offering a more natural and intuitive interaction and by reducing the need for manual support interventions. Additionally, embodiments combine advanced security with user-friendliness, thereby streamlining the authentication process while maintaining high security standards.

As discussed briefly above, cyberspace is particularly difficult to secure due to a number of factors, including the ability of malicious actors to operate from anywhere in the world, the linkages between cyberspace and physical systems, and the difficulty of reducing vulnerabilities and consequences in complex cyber networks. Accordingly, cybersecurity best practices also often recommend an additional security layer for protecting online accounts and sensitive data, such as the use of security questions for password recovery, Multifactor Authentication (MFA) setup, device authorization, and transaction verification. However, these security questions present several challenges and limitations.

One of these challenges includes vulnerability, where easily guessable or publicly available answers undermine the security effectiveness. Accordingly, careful question selection is necessary to avoid easily researched information. Another challenge involves recall difficulty, where users often forget their answers over time, complicating account recovery and leading to potential access issues. One of the limitations involves the need for costly support due to forgotten or compromised answers which necessitate costly manual support interventions. Another limitation involves lack of standardization where the absence of a standardized approach for authorization via security questions creates inconsistencies across platforms thereby creating challenges in secure access management.

One technique to address the existing drawbacks related to security questions can include creating a more dynamic, secure, and standardized authentication system in accordance with one or more embodiments. By moving away from static security questions, the need for users to remember, maintain, and seek support for answers is eliminated, thus reducing the complexities and inefficiencies associated with these traditional methods. Additionally, one or more embodiments place a greater focus on authentication methods based solely on private information that only the user knows which enhances security. Following this approach minimizes the risk of information leakage or having answers guessed by unauthorized parties, thereby ensuring a more secure authentication process according to one or more embodiments. Additionally, by implementing a uniform authentication method across the board for users, devices, and agents, the interoperability among different services and systems can be facilitated. This standardization works to ensure a seamless and secure authentication experience across various platforms, enhancing overall security infrastructure and user convenience.

One or more embodiments leverage commonly available generative AI models (including Large Language Models (LLMs)) to dynamically generate and verify security questions based on private information that is unique to the user, the device, and/or the agent, thereby providing an extra layer of authentication. Generally, one or more embodiments provide a method for generating security questions in real-time or on demand, where the security questions are tailored to the user's recent and/or real-time personal activities or private information about the user, thereby moving away from the traditional and current methods of having a set of static, predefined questions. In one or more embodiments, recent and/or real-time activities may include user activities on a user device within a predefined window of time. For example, the predefined window of time may include a few hours (e.g., 1 hour, 2 hours, 3 hours, 4 hours, etc., or a range of hours), may include a few days (e.g., 1 day, 2 days, 3 days, etc., or a range of days), may exclude certain time periods (e.g., exclude activities that occurred more than 1 week, 2 weeks, 3 weeks, 4 weeks, etc., ago), etc. The method employs advanced semantic analysis for evaluating responses, focusing on the meaning and context, rather than on the exact wording, which allows for a more user-friendly and flexible authentication experience.

By dynamically updating the security questions presented to users based on recent and/or real-time activities of the user, the method makes it more difficult for unauthorized users to predict and/or guess correct answers using old data related to the authorized user. Moreover, the method reduces the operational costs and computer resources associated with customer support for authentication issues, by providing an intelligent and automated nature, while simultaneously simplifying the authentication process. Additionally, the method is universally applicable to all platforms, thereby offering a standardized security solution that can be integrated across various platforms, including human, device, service, and AI agent interactions. Leveraging commonly available generative AI models to dynamically generate security questions based on a user's recent activities, and subsequently verifying their answers, aligns with the goals of dynamism, security, and standardization in authentication. The method enhances security by creating questions based on recent activities to reduce the predictability of questions and to mitigate the risk of unauthorized access. This improves the user experience by providing a frictionless authentication process without the burden of remembering static answers. Also, the method facilitates interoperability to create a standardized, AI-driven approach which ensures consistency across different platforms and systems, thereby enhancing compatibility and security across the digital ecosystem.

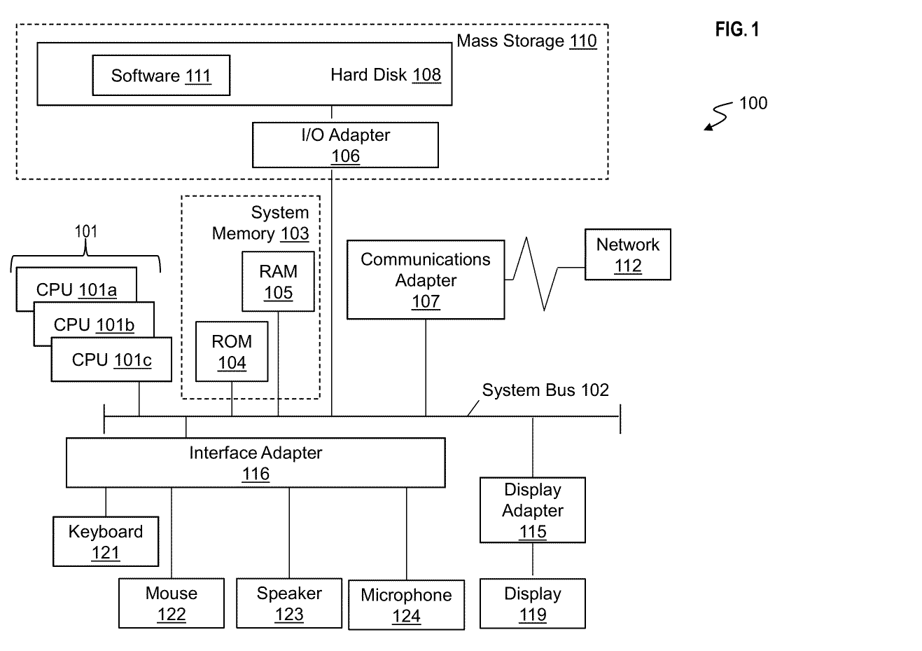

Turning now to FIG. 1, a computer system 100 is generally shown in accordance with one or more embodiments of the invention. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

One or more embodiments described herein can utilize machine learning techniques to perform tasks, such as classifying a feature of interest. More specifically, one or more embodiments described herein can incorporate and utilize rule-based decision making and artificial intelligence (AI) reasoning to accomplish the various operations described herein, namely classifying a feature of interest. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” “a trained classifier,” and/or “trained machine learning model”) can be used for classifying a feature of interest, for example. In one or more embodiments, machine learning functionality can be implemented using an Artificial Neural Network (ANN) having the capability to be trained to perform a function. In machine learning and cognitive science, ANNs are a family of statistical learning models inspired by biological neural networks in nature. ANNs can be used to estimate or approximate systems and functions that depend on a large number of inputs. Convolutional Neural Networks (CNN) are a class of deep, feed-forward ANNs that are particularly useful at tasks such as, but not limited to analyzing visual imagery and natural language processing (NLP). Recurrent Neural Networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

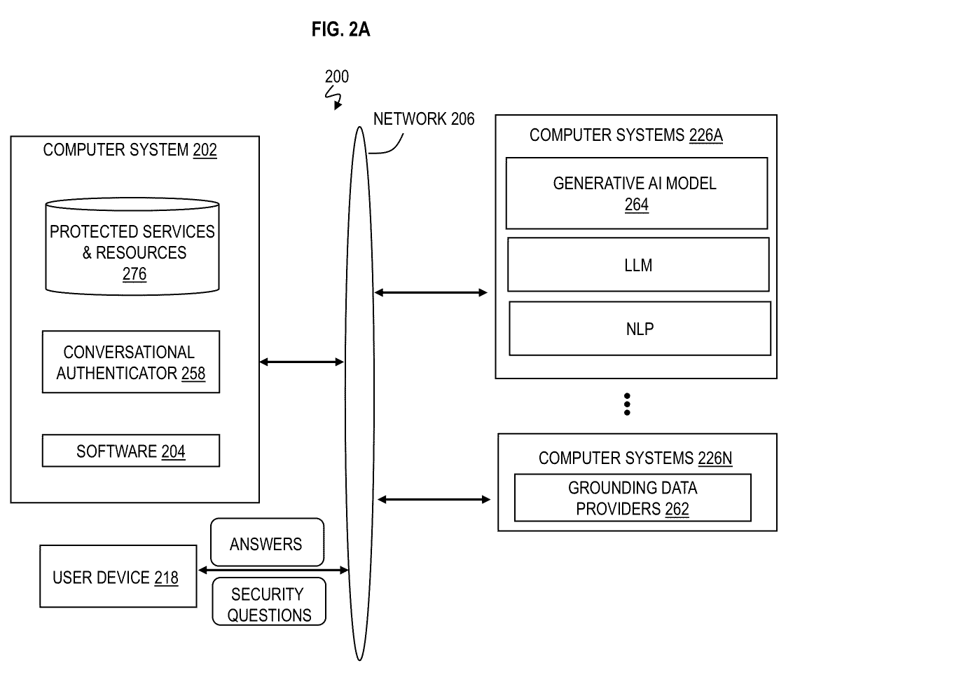

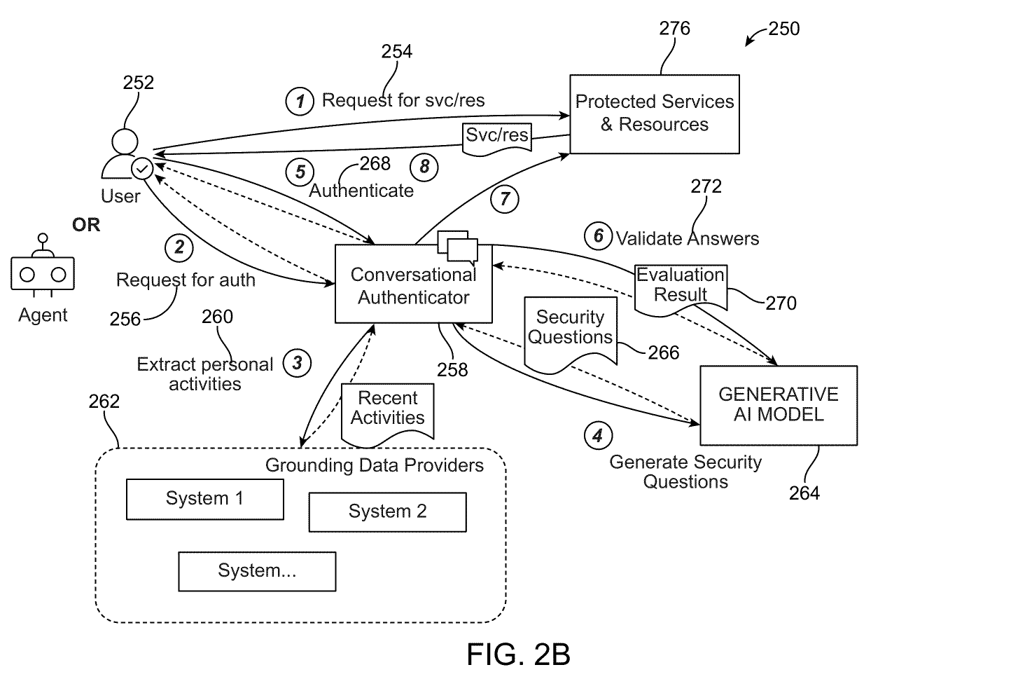

Referring to FIGS. 2A and 2B, a block diagram 200 of an example system configured to generate a security question in real-time for accessing a computer system 202 and a computer-implemented method 250 are shown. In FIGS. 2A and 2B, the security questions are tailored to the user's recent personal activities, recent and/or real-time data about the user, and/or other private information about the user by employing a generative AI engine to perform an advanced semantic analysis for evaluating responses, according to one or more embodiments. In one or more embodiments, the personal activities, recent data, and/or real-time data about the user may be associated with actions on the user device 218. Further, the security questions are generated by focusing on the meaning and context of the wording of the question, rather than on the exact wording to allow for a more user-friendly and flexible authentication experience.

The system includes the computer system 202 having system software 204, a Conversational Authenticator software module 258, and a Protected Services and Resources module 276, where the computer system 202 is configured to communicate over a network 206 with many different computer systems, such as a computer system 226A, through a computer system 226N. The computer system 226A through the computer system 226N can generally be referred to as computer systems 226.

The computer system 202 is configured to communicate with a user 252 via a user device 218 over the network 206. Although a single user device 218 is illustrated in FIG. 2A, the user device 218 can represent numerous user devices 218 connected to the computer system 202. The user device 218 can be a personal computer or laptop. The user device 218 can be a mobile device such as a cellular phone or tablet, or a smart device. A smart device is an electronic device, generally connected to other devices or networks via different wireless protocols that can operate to some extent interactively. Several notable types of smart devices are smartphones, smart speakers, tablets, smartwatches, smart bands, smart glasses, and many others.

The network 206 can be a wired and/or wireless communication network, and the communication network includes a telecommunications network, the public switched telephone network (PTSN), voice over IP (VOIP) network, etc. The communication network includes cellular networks, satellite networks, etc.

The computer systems 226 can include various software and hardware components including software applications (apps) for communicating over the network 206 as understood by one of ordinary skill in the art. The computer systems 226A through 226N can include generative AI models 264 and Grounding Data Providers 262, respectively, to provide generative AI services and grounding data provider services.

The computer system 202, user devices 218 (e.g., computer systems), software 204, Conversational Authenticator software module 258, etc., can include functionality and features of the computer system 100 in FIG. 1 including various hardware components and various software applications such as software 111 which can be executed as instructions on one or more processors 101 in order to perform actions according to one or more embodiments of the invention. The software 204 and the conversational authenticator software module 258 can include, be integrated with, and/or call other pieces of software, algorithms, application programming interfaces (APIs), graphical user interfaces (GUIs) etc., to operate as discussed herein.

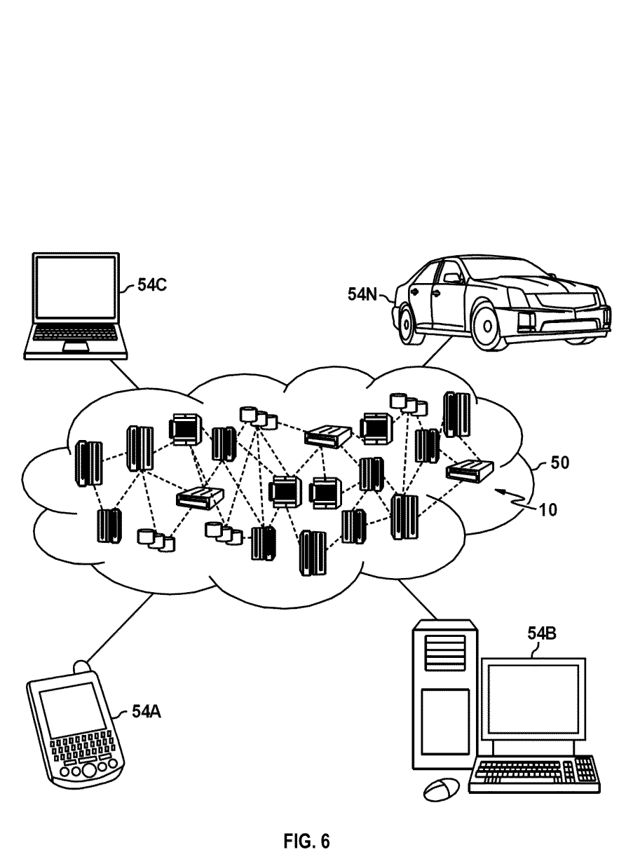

Moreover, the computer system 202 may be representative of numerous computer systems and/or distributed computer systems configured to provide authentication and security services to users of the user devices 218. The computer system 202 can be part of a cloud computing environment such as a cloud computing environment 50 depicted in FIG. 6, as discussed further herein.

Generative AI engines/models use generative artificial intelligence which is a type of AI that can create new content and ideas, including conversations, stories, images, videos, and music. AI technologies attempt to mimic human intelligence in nontraditional computing tasks like image recognition, natural language processing (NLP), and translation. Generative AI is trained to learn human language, programming languages, art, chemistry, biology, or any complex subject matter. Generative AI reuses training data to solve new problems. For example, it can learn the English vocabulary and create a poem from the words it processes. An organization can use generative AI for various purposes. Like all artificial intelligence, generative AI works by using machine learning models such as very large models that are pretrained on vast amounts of data. Examples of very large models can include foundation models and large language models.

Foundation models: Foundation models (FMs) are machine learning models trained on a broad spectrum of generalized and unlabeled data. Foundation models are capable of performing a wide variety of general tasks. Foundation models are the result of the latest advancements in a technology that has been evolving for decades. In general, a foundational model uses learned patterns and relationships to predict the next item in a sequence. For example, with image generation, the foundational model analyzes the image and creates a sharper, more clearly defined version of the image. Similarly, with text, the foundational model predicts the next word in a string of text based on the previous words and their context. The foundational model then selects the next word using probability distribution techniques.

Large language models: Large language models (LLMs) are one class of foundational models. LLMs are specifically focused on language-based tasks such as such as summarization, text generation, classification, open-ended conversation, and information extraction.

Referring to FIG. 2B, an overall block diagram illustrating an embodiment of a computer-implemented method 250 for generating an authentication security question using one or more commonly available generative AI models 264 is generally shown and includes a user/agent 252 on the user device 218 requesting 254 protected services and/or resources (Svc/res), such as password recovery, Multifactor Authentication (MFA) setup, translation verification, device authorization, etc.

At operation 1, the user/agent 252 on the user device 218 makes a request 254 for the protected services and/or resources. The request 254 may be made using the user device 218 or any other user device.

At operation 2, in response to making the request 254 for the protected services and/or resources, a request for authorization 256 for the user device 218 is communicated to a Conversational Authenticator (CA) software module 258.

At operation 3, the CA software module 258 extracts and obtains personal and/or recent activities 260 of the user/agent 252 from grounding data providers 262 on computer system 226N. It should be appreciated that the grounding data providers 262 may include a grounding LLM which is configured for Retrieval-Augmented Generation (RAG) using a RAG software model. The grounding data of the grounding data providers 262 may include Identity and Access Management (IAM) data, user creation time data, user last login time data, user logins with a predefined time period (e.g., last week, etc.), user real-time and past activities (e.g., user created a subscription on Jul. 25^{th}, upgraded capacity on Aug. 10^{th}, etc.), and user audit trails (e.g., user invited another user on Jul. 30^{th}, deleted the user on Aug. 5^{th}, etc.).

It should be appreciated that the Retrieval-Augmented Generation (RAG) process is an advanced AI technique that uses a RAG software model to combine two AI components: a retrieval component and a generation component. The retrieval component involves the RAG model accessing a large dataset or database of documents, such as a "grounding data provider", to retrieve information about a user, such as a user's past activities, real-time data, and/or other private knowledge about the user. This helps to ensure the user information that is used to craft the security question is the most accurate, up-to-date, and relevant information available. Once the retrieval component is accomplished, the RAG model uses the retrieved information as a grounding or contextual guide for generating new, semantically robust and contextually relevant security questions, which are dynamic and personalized by being based on recent user activity and/or private knowledge. The RAG model uses this retrieved information to generate a security question specifically tailored to the user. This generation process is not random, but rather is guided by the user’s data to ensure that the generated question is relevant to the user. This helps to reduce predictability for unauthorized users. Accordingly, the combination of the retrieval component and the generation component ensures that the security questions are contextually grounded in real-time, private user data, while maintaining the flexibility and robustness of generative AI models like LLMs. This makes it more difficult for attackers to predict or guess the security questions, thereby enhancing security.

At operation 4, the CA software module 258 requests a generative AI model 264 to dynamically generate security questions 266 based on the personal/recent activities of the user/agent 252 on user device 218. In one or more embodiments, the user may have more than one user device 218. In accordance with one or more embodiments, the security questions can be generated based on a combination of personal/recent activities of the user/agent 252 for any of the user devices 218. The CA software module 258 receives and communicates the security questions 266 to the user/agent 252 of the user device 218 for an answer.

At operation 5, once the user/agent 252 answers the security questions 266, the answers to the security questions are communicated to the CA software module 258 for authentication 268.

At operation 6, the CA software module 258 transfers the answers 272 to the generative AI model 264 for validation, and the generative AI model 264 outputs evaluation results 270 back to the CA software module 258. For example, in addition to the answers 272, the CA software module 258 transfers both the security questions 266 and the personal and/or recent activities of the user/agent 252 utilized to dynamically generate the security questions 266 to the generative AI model 264. The CA software module 258 requests/instructs the generative AI model 264 to validate whether the answers 272 are correct based on the security questions 266 and personal and/or recent activities. The CA software module 258 validates the answers of the user/agent and provides the evaluation result 270 to the CA software module 258.

In accordance with one or more embodiments, the generative AI model 264 may evaluate the user’s answers by performing a semantic analysis of the user’s answers to evaluate the meaning and context of the answer and by comparing the user’s answers to the retrieved knowledge (e.g., grounding data) that was used to generate the security question. In one or more embodiments, the generative AI model 264 may use Natural Language Processing (NLP) techniques to understand if the user's answer is contextually and logically correct based on the user's personal history. For example, even if a user phrases their answer in a different manner than what is expected, as long as the meaning is accurate (e.g., "I logged in on Monday and Wednesday" versus "I accessed my account earlier this week"), the generative AI model 264 validates the answer as being correct. Accordingly, the evaluation of the user’s answers may be based on several factors, including context matching (e.g., whether the user's response aligns with the recent activities or data that were used to generate the question), semantic accuracy (e.g., the generative AI model 264 assesses whether the meaning and intent of the user's response match the expected answer, regardless of the specific wording used), and/or a confidence threshold (e.g., the generative AI model 264 may generate a confidence score based on how closely the response aligns with the correct answer, where if the score exceeds a predefined confidence threshold, the response is considered valid). It should be appreciated that the validation process may focus on the meaning and context of the user's response rather than on whether the answer is an exact match. This approach enhances the user experience and security by allowing more natural interactions and by reducing the chances of rejecting valid responses due to minor phrasing differences.

At operations 7 and 8, when the evaluation result 270 confirms that the answers of the user/agent 252 are correct, the CA software module 258 instructs the protected services and resource module 276 to provide the protected services and resources to user device 218 of the user/agent 252. For example, once the generative AI model 264 completes evaluating the user’s answer semantically, the generative AI model 264 sends the result of the evaluation back to the CA software module 258. If the user’s answer is determined to be correct (e.g., the semantic meaning aligns with the user's known activities), then the user is granted access. When the CA software module 258 determines that the evaluation result 270 rejects the answers, the CA software module 258 can repeat the authentication process for a predefined number of times using different data of the protected services and resource and/or eventually deny the request if the answer is incorrect.

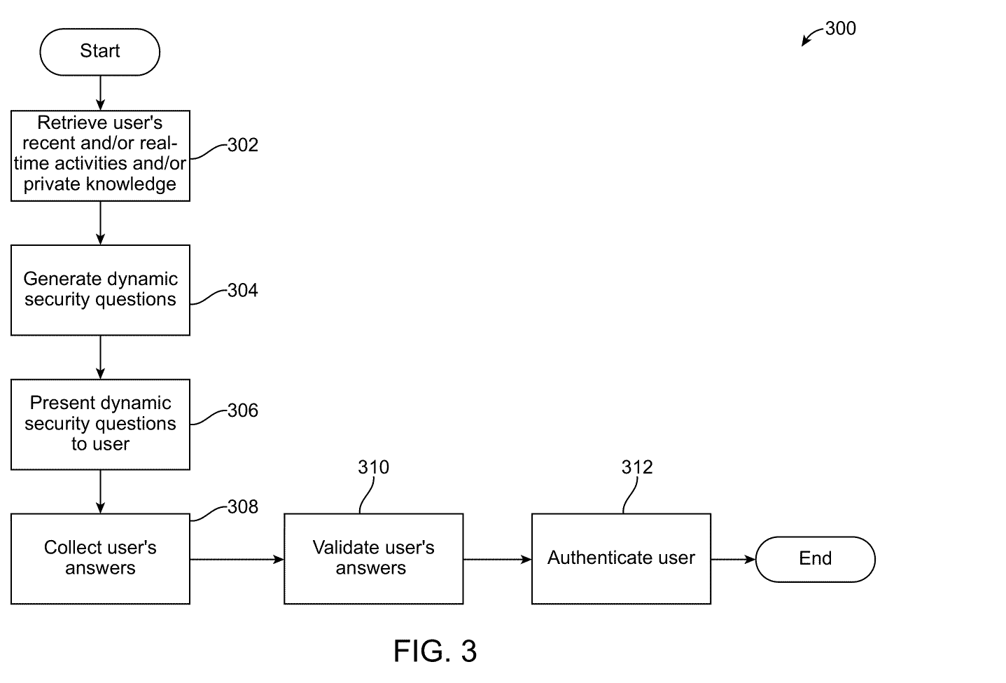

Referring to FIG. 3, a flow diagram illustrating an embodiment of a computer-implemented method 300 for generating an authentication security question using a generative AI model 264 is shown. At block 302, the CA software module 258 can retrieve/obtain user information including the recent activities, real-time activities, and private knowledge of the user/agent 252. In one or more embodiments, the software 204 can instruct the CA software module 258 to obtain the user information from the grounding data providers 262. The user information can be collected using various techniques. The grounding data providers 262 of computers systems 226 and/or the software 204 may provide software that is installed on the user device 218 of the user/agent 252, and the installed software collects and provides the user information of user device 218 to the grounding data providers 262.

At block 304, the CA software module 258 can instruct the generative AI model 264 to dynamically generate security questions based on the user information that is only known by the user/agent 252. The CA software module 258 receives the security questions from the generative AI model 264. The security questions are tailored to the user information known only to the user/agent 252. For instance, the security questions may be about user information including the recent activities, real-time activities, and private knowledge of the user/agent 252. Examples of the user information on which the security questions are based can include user recent tickets, user location based information (e.g., from GPS data of the user device 218), user historical patterns (e.g., recently traveled locations), user account changes, user sentiment based information, user created content (e.g., user created images, music, videos, posts, likes, dislikes, etc.), user imaginary scenarios, user biometric based information, etc.

At blocks 306 and 308, the CA software module 258 can present the dynamically generated security questions to the user/agent 252 on user device 218 and receive/collect the answers from the user/agent 252. In one or more embodiments, the dynamically generated security questions can be graphically displayed, audibly presented, holographically presented, played as a video, etc., on the user device 218. As example security questions presented to the user, the CA software module 258 and/or the software 204 can present the following two questions: (1) On which days did you log into the XYZ app? (2) On which day did you create a new subscription? The following are example answers by the user/agent: (1) Monday, Wednesday, Friday. (2) Monday.

At block 310, the CA software module 258 requests the generative AI model 264 to validate the answers of the user/agent 252 based on the user information including the recent activities, real-time activities, and private knowledge and the dynamically generated security questions. The generative AI model 264 may determine whether the answers are correct or incorrect.

At block 312, in response to the user providing the correct answers to the security questions as validated by the generative AI model 264, the CA software module 258 authenticates the user/agent 252 of user device 218. Accordingly, the user/agent 252 of user device 218 is granted access to the protected services and resources provided by the protected services and resource module 276. In response to the user providing the incorrect answers to the security questions, the CA software module 258 denies access to the protected services and resources.

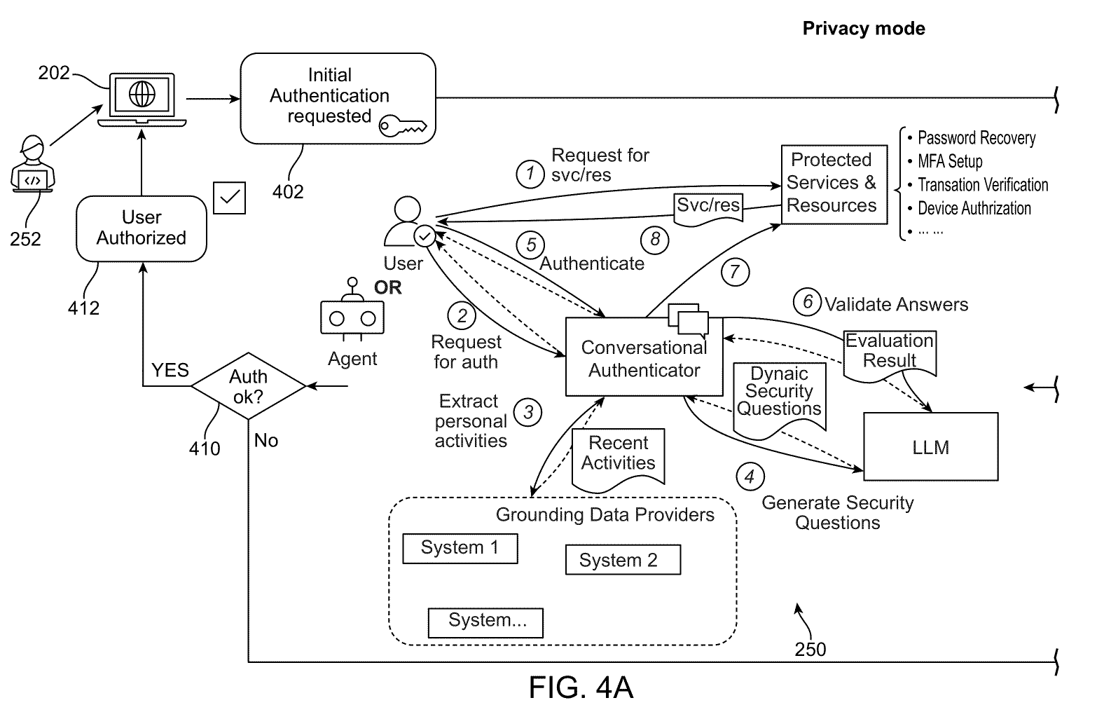

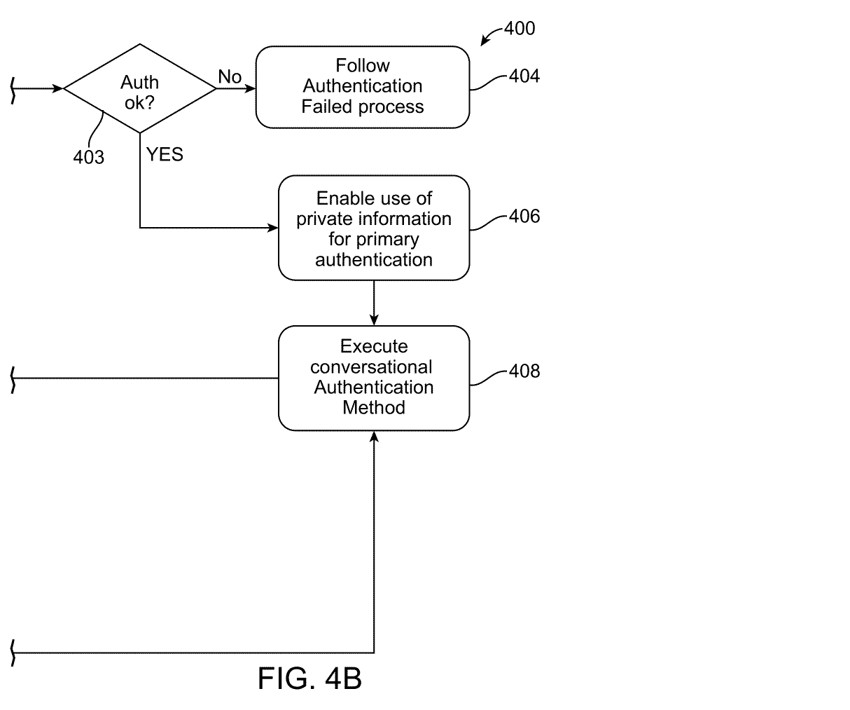

FIGS. 4A and 4B depict a block diagram of a computer-implemented method 400 with a privacy mode for generating an authentication security question using a generative AI model 228. FIGS. 4A and 4B illustrate successfully traversing an initial authentication method or ‘Privacy Mode’ of computer-implemented method 400, prior to executing the method 250 for generating an authentication security question. In one or more embodiments, the initial authentication method functions as an initial authentication mechanism prior to being allowed to access the primary authentication mechanism, which provides for a more secure system. The privacy mode protects user data from being harvested by an attacker (e.g., unauthorized user) abusing/interrogating the system/network via the computer system 202. For example, the attacker may wish to gather data about the user by reading the questions presented during the authentication process.

The computer-implemented method 400 includes a user/agent 252 operating the user device 218 to attempt to gain access to the computer system 202. The software 204 enters the privacy mode. In response, the software 204 of computer system 202 generates a request for initial authentication at block 402, where the user/agent 252 is required to enter credentials, for example, a username and password. In one or more embodiments, other types of credentials may be entered including biometric identification information, multifactor authentication information, etc.

At block 403, the software 204 of computer system 202 checks if the credentials are correct. At block 404, if the initial authentication at block 402 attempt fails, the software 204 proceeds to an authentication failed process. For example, in an embodiment, when the user/agent 252 attempts to log into the computer system 202 via the initial authentication method (e.g., username/password at block 402) and fails, the software 204 can present an error message to the user/agent 252.

At block 406, if the initial authentication at block 402 is successful, the software 204 of computer system 202 enables the use of private information of the user/agent 252 to be used for primary authentication. At block 408, the software 204 invokes the method 250 (depicted in FIG. 2A) for generating an authentication security question with user information by employing one or more generative AI models 264 as discussed herein for primary authentication.

At blocks 410 and 412, when the primary authentication of method 250 is successful, the software 204 and/or CA software module 258 authorizes the user 252 to be granted access to the protected services and resources by the protected services and resources module 276. Accordingly, the user device 218 can access, view, download, modify, interact with, experience, etc., one or more protected services and resources by the protected services and resources module 276. When the primary authentication of method 250 is unsuccessful, the software 204 and/or CA software module 258 can invoke the method 250 (depicted in FIG. 2A) again for generating the authentication security question a predetermined number of times before discontinuing.

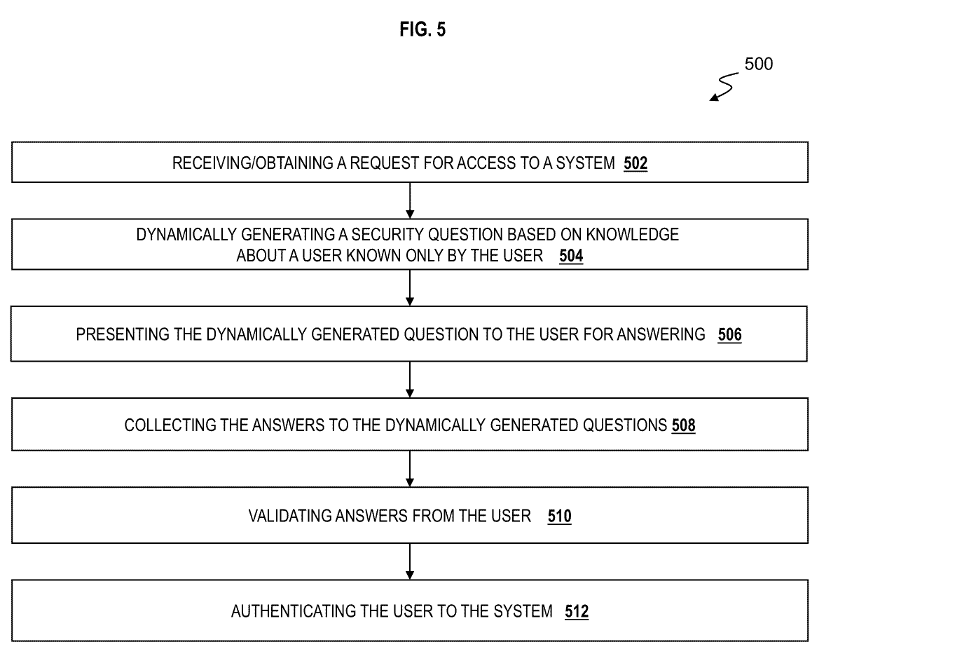

FIG. 5 depicts a flowchart of a computer-implemented method 500 for generating an authentication security question using generative AI models according to one or more embodiments. Reference can be made to any figures discussed herein. At block 502, the method 500 includes receiving a request for access to protected services and resources on the computer system 202 by a user/agent 252 via a user device 218. This may be accomplished by the user 252 attempting to log into an online system such as the computer system 202 or a network computer system.

At block 504, the method 500 further includes dynamically generating at least one security question via the CA software module 258 and the generative AI model 264 based on user information about the user/agent 252 known only to the user 252. For example, after the user 252 requests access to protected services and resources on the computer system 202, the request of user/agent 252 is forwarded to the CA software module 258 which extracts and obtains personal and/or recent activities 260 of the user/agent 252 collected from network 206 and/or online grounding data providers 262. The CA software module 258 interacts with the generative AI model 264 to dynamically generate security questions 266 based on user information including the personal information and/or recent/real-time activities of the user/agent 252. It should be appreciated that dynamically generating security questions may be based on user recent internet activities, current real-time data, user recently purchased tickets/products, user location based information, user internet historical patterns, user account changes, user sentiment based information, user created content, user imaginary scenarios, user biometric based information, etc.

At block 506, the method 500 presents the dynamically generated security question to the user/agent 252 and the user/agent 252 is prompted to enter an answer to the security question. At blocks 508 and 510, the method 500 collects the answer to the dynamically generated security question and the answer is then validated. This may be accomplished by the CA software module 258 interacting with the generative AI model 264 to evaluate the answers of the user/agent 252, where an advanced semantic analysis may be applied to evaluate the answers, focusing on the meaning and the context of the answers, rather than on the exact wording of the answers. It should be appreciated that whether an advanced semantic analysis is performed or not depends on the complexity of the generated security question. For example, if the generated security question is a simple question (e.g., “When did you last update your profile?”), there is no need for the method to perform an advanced semantic analysis. However, if the generated security question is a complex question (e.g., “Are you happy about the service ticket resolution performed last week?”), the method can perform an advanced semantic analysis to determine what the context of the answer to the question should be (e.g., the user should be unhappy if the user gave a thumbs-down selection or escalated the service ticket). In this case, the method may conduct an advanced semantic analysis using known standard techniques, natural language processing (NLP) techniques, and/or large language model-based techniques. At block 512, the results of the evaluation are sent to the CA software module 258 which authenticates the user/agent 252. Accordingly, the user/agent 252 is allowed access to the protected system services and system resources on the computer system 202 and possibly other remote servers and systems.

As discussed herein, one or more embodiments provide technical effects and solutions that automatically verify user responses semantically, rather than relying on exact text matches. This approach significantly improves the user experience by offering a more natural and intuitive interaction and reduces the need for manual support interventions. As technical effects and solutions, one or more embodiments combine advanced security with user-friendliness, streamlining the authentication process while maintaining high security standards. Moreover, by moving away from static security questions, the need for users to remember, maintain, and seek support for answers is eliminated, thereby reducing the complexities and inefficiencies associated with traditional and current methods. By having authentication methods based solely on private information that only the user knows, this approach minimizes the risk of information being successfully guessed by unauthorized parties, ensuring a more secure authentication process. Furthermore, one or more embodiments automate the creation of up-to-date, personalized security questions from the user’s recent activities, thereby improving relevance and security. Additionally, one or more embodiments provide a fully automated generation and verification method that uses generative AI models, eliminates human error, increases efficiency and scalability, and utilizes sensitive information known only to the legitimate party. Further, embodiments make remembering answers easier due to the relevance of questions (reducing user frustration and support needs), readily adapt to evolving security threats and behaviors, ensure long-term viability and robustness against new challenges, and offer a flexible yet standardized authentication method applicable across various platforms.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Moreover, it should be appreciated that in one or more embodiments, the computer system 100 shown in FIG. 1 and the computer system 202 shown in FIG. 2A may be used, in whole or in part, to practice one or more of the features/aspects of the invention. For example, in an embodiment, the computer system 202 in FIG. 2A may be used to practice the method shown in FIG. 5. The computer system 202 in FIG. 2A may further include processors which execute instructions that practice the processes in FIGS. 2B-5, including the use of machine learning models, such as commonly available generative AI models 264 and the use of reinforcement learning models.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

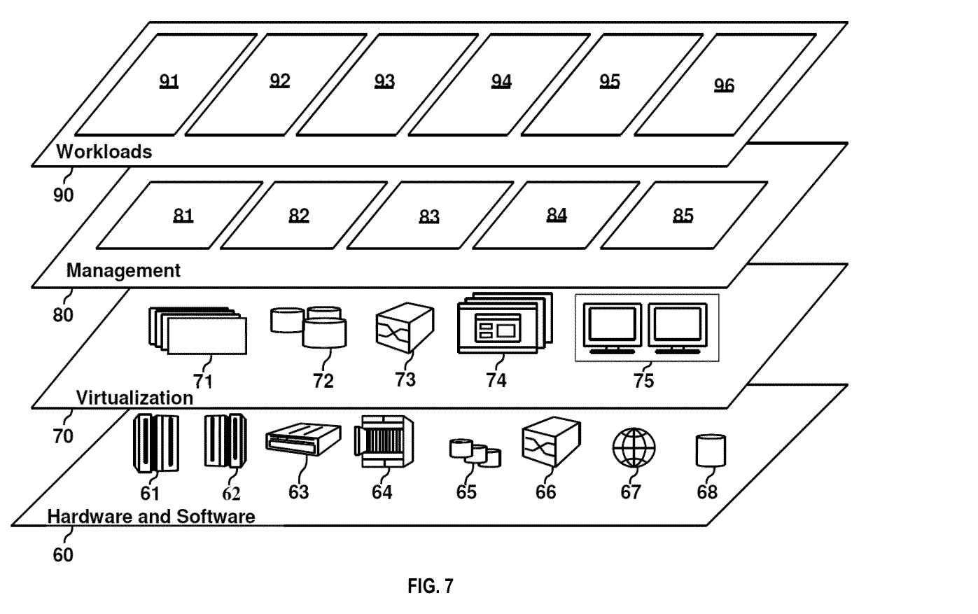

Referring now to FIG. 7, a set of functional abstraction layers provided by cloud computing environment 50 (depicted in FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and workloads and functions 96. One or more aspects of embodiments may be executed, at least in part, by workloads and functions 96. In one or more embodiments, the software 204, the software module 258, software module 276, the LLM, the generative AI engines, etc., can utilize, be executed as, and/or be integrated with workloads and functions 96.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, e.g., one, two, three, four, etc. The terms “a plurality” are understood to include any integer number greater than or equal to two, e.g., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ± 8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the "C" programming language or similar programming languages. The computer readable program instructions may execute entirely on the user’s computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computed-implemented method comprising:
receiving a request from a user to access a protected resource;
generating an authentication security question based on knowledge about the user, wherein receiving the request causes the authentication security question to be generated;
presenting the authentication security question to the user; and
in response to a user answer for the authentication security question being correct, granting the user access to the protected resource.

2. The computer-implemented method of claim 1, wherein:
the receiving the request includes the user attempting to access an online system; and
the authentication security question is generated in real-time.

3. The computer-implemented method of claim 1, wherein:
the generating the authentication security question includes obtaining user information known to the user; and
the user information includes personal activities of the user and real-time data about the user.

4. The computer-implemented method of claim 1, wherein the generating the authentication security question based on the knowledge about the user comprises causing an artificial intelligence (AI) model to generate the authentication security question based on the knowledge about the user.

5. The computer-implemented method of claim 1, further comprising validating the user answer using semantic analysis to determine at least one of a meaning or a context of the user answer.

6. The computer-implemented method of claim 1, further comprising causing an AI model to evaluate the user answer for at least one of a meaning or a context using the knowledge about the user and the authentication security question presented to the user.

7. The computer-implemented method of claim 1, further comprising executing an initial authentication prior to generating the authentication security question, wherein passing the initial authentication function determines that the knowledge about the user is to be utilized to generate the authentication security question.

8. A system comprising:
a memory having computer readable program instructions; and
one or more processors for executing the computer readable program instructions, the computer readable program instructions controlling the one or more processors to perform operations comprising:
receiving a request from a user to access a protected resource;
generating an authentication security question based on knowledge about the user, wherein receiving the request causes the authentication security question to be generated;
presenting the authentication security question to the user; and
in response to a user answer for the authentication security question being correct, granting the user access to the protected resource.

9. The system of claim 8, wherein:
the receiving the request includes the user attempting to access an online system; and
the authentication security question is generated in real-time.

10. The system of claim 8, wherein:
the generating the authentication security question includes obtaining user information known to the user; and
the user information includes personal activities of the user and real-time data about the user.

11. The system of claim 8, wherein the generating the authentication security question based on the knowledge about the user comprises causing an artificial intelligence (AI) model to generate the authentication security question based on the knowledge about the user.

12. The system of claim 8, wherein the one or more processors perform operations further comprising validating the user answer using semantic analysis to determine at least one of a meaning or a context of the user answer.

13. The system of claim 8, wherein the one or more processors perform operations further comprising causing an AI model to evaluate the user answer for at least one of a meaning or a context using the knowledge about the user and the authentication security question presented to the user.

14. The system of claim 8, wherein the one or more processors perform operations further comprising executing an initial authentication prior to generating the authentication security question, wherein passing the initial authentication determines that the knowledge about the user is to be utilized to generate the authentication security question.

15. A computer program product comprising a computer readable storage medium having computer readable program instructions embodied therewith, the computer readable program instructions executable by one or more processors to cause the one or more processors to perform operations comprising:
receiving a request from a user to access a protected resource;
generating an authentication security question based on knowledge about the user, wherein receiving the request causes the authentication security question to be generated;
presenting the authentication security question to the user; and
in response to a user answer for the authentication security question being correct, granting the user access to the protected resource.

16. The computer program product of claim 15, wherein:
the receiving the request from the user includes the user attempting to access an online system; and
the authentication security question is generated in real-time.

17. The computer program product of claim 15, wherein:
the generating the authentication security question includes obtaining user information known to the user; and
the user information includes personal activities of the user and real-time data about the user.

18. The computer program product of claim 17, wherein the generating the authentication security question based on the knowledge about the user comprises causing an artificial intelligence (AI) model to generate the authentication security question based on the knowledge about the user.

19. The computer program product of claim 15, further comprising validating the user answer using semantic analysis to determine at least one of a meaning or a context of the user answer.

20. The computer program product of claim 15, further comprising executing an initial authentication prior to generating the authentication security question, wherein passing the initial authentication determines that the knowledge about the user is to be utilized to generate the authentication security question.
